(19) United States
(12) Patent Application Publication
(10) Pub. No.: US 2016/0271780 A1
(43) Pub. Date: Sep. 22, 2016

(54) Shock Absorption Device for Pneumatic Tool

(71) Applicant: Jhih Jhong Lin, Yilan County (TW)

(72) Inventor: Jhih Jhong Lin, Yilan County (TW)

(21) Appl. No.: 14/662,297

(22) Filed: Mar. 19, 2015

(51) Int. Cl. B25D 17/24; B25D 9/04

(52) U.S. Cl. CPC B25D 17/24; B25D 9/04

(57) ABSTRACT

A shock absorption device for a pneumatic tool, wherein a pneumatic tool contains: a body, a cylinder, a valve unit, and a piston member. The body includes a grip and a fitting sleeve fitted with the grip, wherein the fitting sleeve has a chamber, a close face formed on a first end thereof, and an opening formed on a second end thereof. The cylinder slidably is fixed in the chamber and a part thereof extends out of the opening, the cylinder includes a room and an abutting portion adjacent to the close face. The valve unit is fixed between the room and the abutting portion of the cylinder. The piston member is accommodated in the room and slides forward and backward along a movement axis. Plural buffer springs are mounted in the chamber and abut against the close face of the fitting sleeve and the abutting portion of the cylinder.

### BACKGROUND OF THE INVENTION

1. Field of the Invention

The present invention relates to a shock absorption structure, and more particularly to a shock absorption device for a pneumatic tool which reduces operating vibration.

2. Description of the Prior Art

A conventional pneumatic tool is driven by a high pressure air used as a power source. With reference to FIG. 14, the conventional pneumatic tool contains: a grip 10, a valve unit 20, a cylinder 30, and a piston member 40, wherein the grip 10 includes an air inlet segment 101 connected with a high pressure air, an air passage 102 communicating with the air inlet segment 101, a control switch (not shown) for controlling air to flow into the air inlet segment 101, and a cylindrical portion 103. The cylindrical portion 103 has a chamber 104 defined therein and communicating with the air passage 102. The valve unit 20 is mounted in the chamber 104 of the cylindrical portion 103, and one end of the cylinder 30 is inserted into the chamber 104 of the cylindrical portion 103, such that the cylinder 30 contacts with the valve unit 20. The cylinder 30 includes a room 301 defined therein and a flowing channel 302 formed between a front end of the room 301 and the valve unit 20, wherein the flowing channel 302 is in communication with the front end of the room 302 and the valve unit 20, and the piston member 40 is accommodated and slides in the room 301 of the cylinder 30. When turning on the control switch on the grip 10, the high pressure air flows into the valve unit 20 in the chamber 104 of the cylindrical portion 03 from the air inlet segment 101 of the grip 10 via the air passage 102, and the valve unit 20 controls the high pressure air 30 flows into the room 301 of the cylinder 30 to push the piston member 40 toward a predetermined position, such that a tool head (not shown) is hit by the piston member 40, and the tool head stops the piston member 40, thereafter the valve unit 20 controls the high pressure air to flow into a front end of the room 301 of the cylinder 30 through the flowing channel 302, such that the piston member 40 is pushed by the high pressure air to slide backward to impact the valve unit 20, hence the piston member 40 is stopped by the valve unit 20, thus moving the piston member 40 to operate the pneumatic tool.

However, when the piston member 40 slides backward to impact the valve unit 20, a reaction force produces and passes toward user's hand, thus gripping the pneumatic tool difficultly and hurting the user's waist easily.

To overcome above-mentioned problem, a single spring is fixed in the chamber of the cylindrical portion, such that the single spring cushions impact force, when the piston member 40 slides backward to impact the valve unit 20, thereby decreasing reaction force which passes toward the user's hand. Nevertheless, the single spring cannot cushion the impact force evenly to reduce the reaction force.

The present invention has arisen to mitigate and/or obviate the afore-described disadvantages.

### SUMMARY OF THE INVENTION

The primary objective of the present invention is to provide a shock absorption device for a pneumatic tool in which plural buffer springs are mounted in a chamber of a fitting sleeve and abut against a close face of a chamber of a fitting sleeve and an abutting portion of a cylinder, such that plural elastic supporting points form between the close face and the abutting portion, and when a piston member moves backward to impact a valve unit, the plural buffer springs buffer and reduce a reaction force which passes to user's hand, thus operating the pneumatic tool easily and protecting the user's wrist.

To obtain above-mentioned objective, a shock absorption device for a pneumatic tool provided by the present invention contains: a body, a cylinder, a valve unit, and a piston member.

The body includes a grip and a fitting sleeve fitted with the grip, the fitting sleeve has a chamber defined therein, a close face formed on a first end thereof, and an opening formed on a second end thereof.

The cylinder is slidably fixed in the chamber of the fitting sleeve and a part thereof extends out of the opening of the fitting sleeve, the cylinder includes a room defined therein and an abutting portion adjacent to the close face of the chamber of the fitting sleeve.

The valve unit is fixed between the room and the abutting portion of the cylinder.

The piston member is accommodated in the room of the body and slides forward and backward along a movement axis; plural buffer springs are mounted in the chamber of the fitting sleeve and abut against the close face of the chamber of the fitting sleeve and the abutting portion of the cylinder, wherein a pressing direction of each buffer spring is parallel to the movement axis of the piston member, and plural elastic supporting points form between the close face and the abutting portion.

### BRIEF DESCRIPTION OF THE DRAWINGS

FIG. 1 is a perspective view showing the assembly of a pneumatic tool according to a preferred embodiment of the present invention.

FIG. 2 is a perspective view showing the exploded components of the pneumatic tool according to the preferred embodiment of the present invention.

FIG. 3 is a perspective view showing the assembly of a sliding sleeve of the pneumatic tool according to the preferred embodiment of the present invention.

FIG. 4 is a cross sectional view showing the assembly of the pneumatic tool according to the preferred embodiment of the present invention.

FIG. 5 is a cross sectional view taken along the line A-A of FIG. 4.

FIG. 6 is a cross sectional view showing the operation of the pneumatic tool according to the preferred embodiment of the present invention.

FIG. 7 is another cross sectional view showing the operation of the pneumatic tool according to the preferred embodiment of the present invention.

FIG. 8 is also another cross sectional view showing the operation of the pneumatic tool according to the preferred embodiment of the present invention.

FIG. 9 is a cross sectional view showing the assembly of a pneumatic tool according to another preferred embodiment of the present invention.

FIG. 10 is a cross sectional view showing the assembly of a pneumatic tool according to another preferred embodiment of the present invention.

FIG. 11 is an amplified cross sectional view of a part of FIG. 10.

FIG. 12 is a cross sectional view showing the operation of the pneumatic tool according to another preferred embodiment of the present invention.

FIG. 12 is a cross sectional view taken along the line B-B of FIG. 10.

FIG. 14 is a cross sectional view of a conventional pneumatic tool.

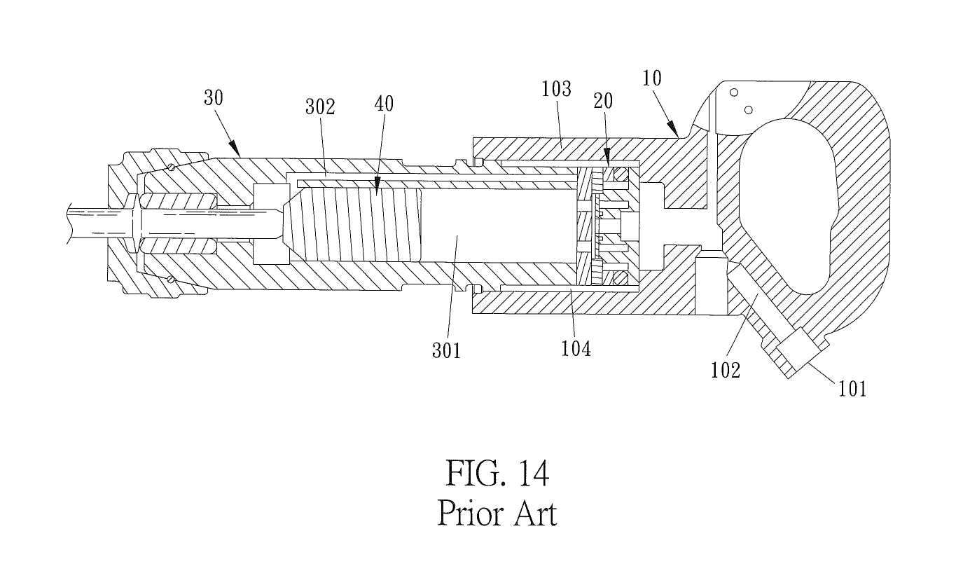

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

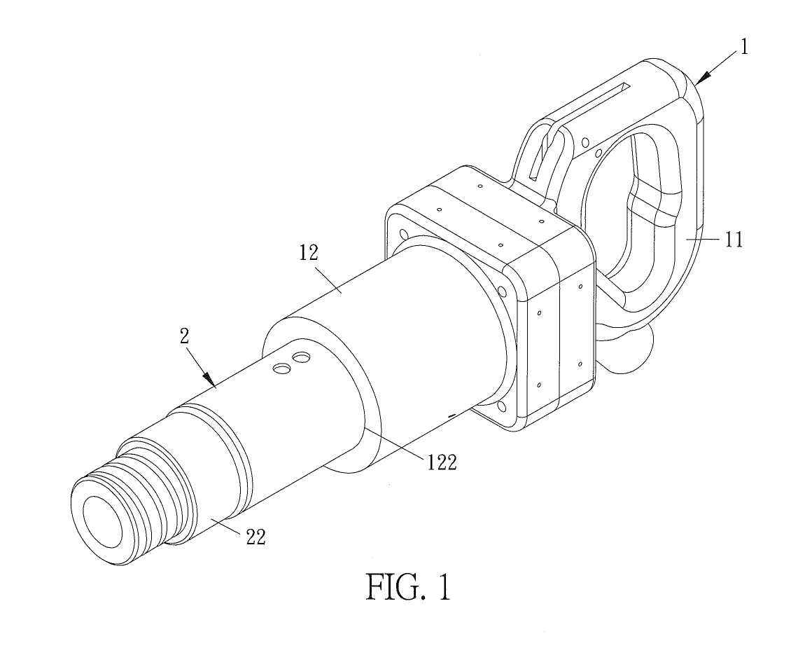

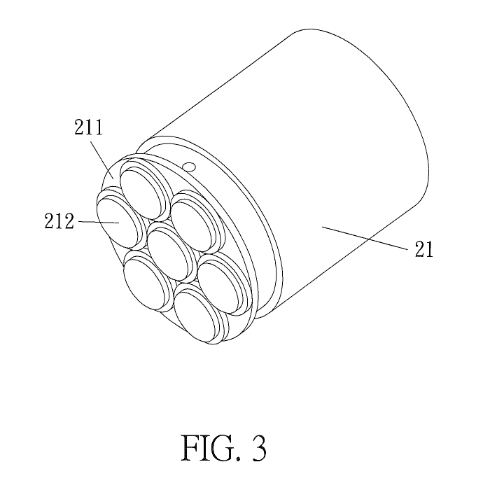

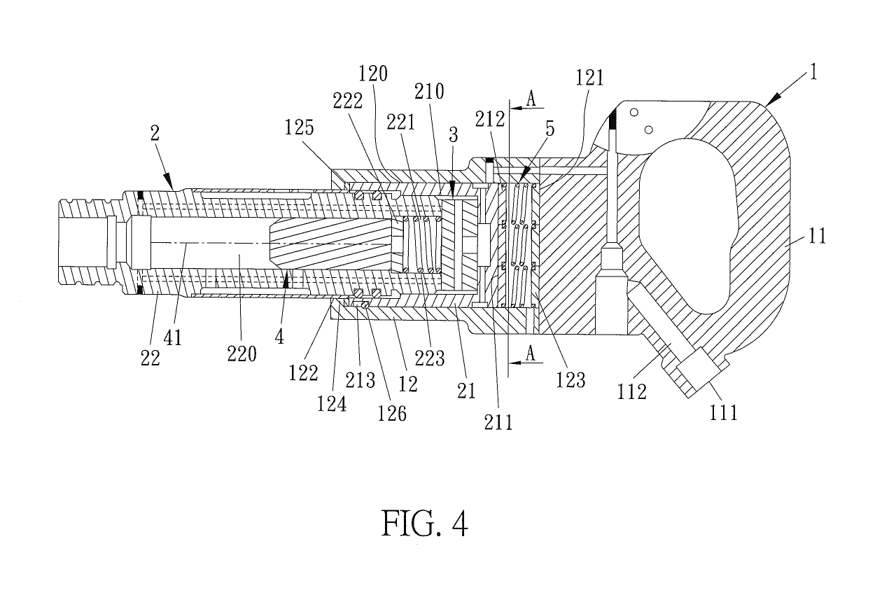

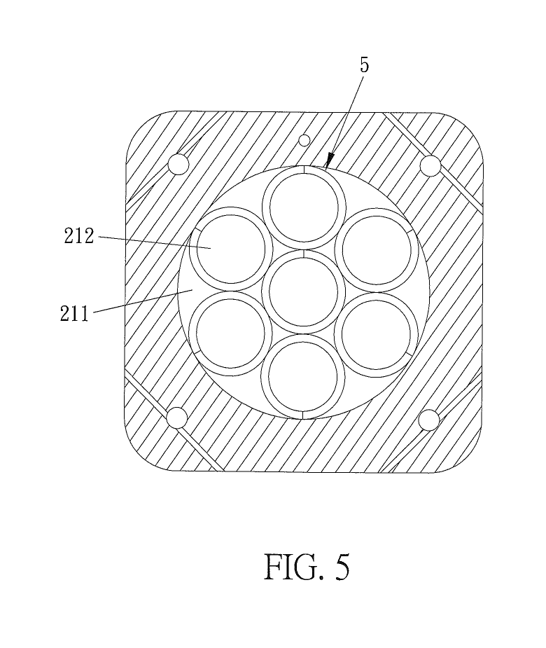

With reference to FIGS. 1 to 5, a shock absorption device for a pneumatic tool according to a preferred embodiment of the present invention, wherein the pneumatic tool comprises: a body 1, a cylinder 2, a valve unit 3, a piston member 4, and plural buffer springs 5, wherein the body 1 includes a grip 11 and a fitting sleeve 12 fitted with the grip 11, the grip 11 has an air inlet segment 111, an air passage 112 communicating with the air inlet segment 111, and a control switch (not shown) for controlling air to flow into the air inlet segment 111; the fitting sleeve 12 has a chamber 120 defined therein, a close face 121 formed on a first end thereof, an opening 122 formed on a second end thereof, a plurality of first fixing portions 123 annularly arranged on the close face 121, and a stop rib 124 extending inwardly from a peripheral side of the opening 122. The cylinder 2 includes a sliding sleeve 21 and a base 22, wherein the sliding sleeve 21 is slidably fitted in the chamber 120 of the fitting sleeve 12, and the sliding sleeve 21 has a hollow portion 210 formed therein, an abutting portion 211 adjacent to the close face 121 of the chamber 120 of the fitting sleeve 12, and a plurality of second fixing portions 212 annularly arranged on one surface of the abutting portion 211 opposite to the close face 121 of the chamber 120 of the fitting sleeve 12 and corresponding to the plurality of first fixing portions 123. The sliding sleeve 21 is stopped by a washer 125 for matching with the stop rib 124 of the fitting sleeve 12, and the sliding sleeve 21 has a limiting slot 213 defined on an outer side thereof to insert a defining element 126 of the fitting sleeve 12, wherein one end of the base 22 is inserted into the hollow portion 210 of the sliding sleeve 21 and is connected with the sliding sleeve 21 in a screwing manner, a part of the base 22 extends out of the opening 122 of the chamber 120 of the fitting sleeve 12, and the base 22 has a room 220 defined therein, the room 220 has an expanding groove 221 formed on a rear end thereof, the expanding groove 221 has a circular moving element 222 and a compression spring 223. The valve unit 3 is fixed between the room 220 and the abutting portion 211 of the cylinder 2, such that high pressure air flows toward the valve unit 3 via the air passage 112 of the grip 11. The piston member 4 is accommodated in the room 220 of the base 22 and slides forward and backward along a movement axis 41. The plural buffer springs 5 are circularly mounted in the chamber 120 of the fitting sleeve 12 and abut against the close face 121 of the chamber 120 of the fitting sleeve 12 and the abutting portion 211 of the sliding sleeve 21 of the cylinder 2, wherein two ends of each buffer spring 5 are fitted with each first fixing portion 123 of the close face 121 and each second fixing portion 212 of the abutting portion 211, such that a pressing direction of each buffer spring 5 is parallel to the movement axis 41 of the piston member 4, and plural elastic supporting points form between the close face 121 and the abutting portion 211.

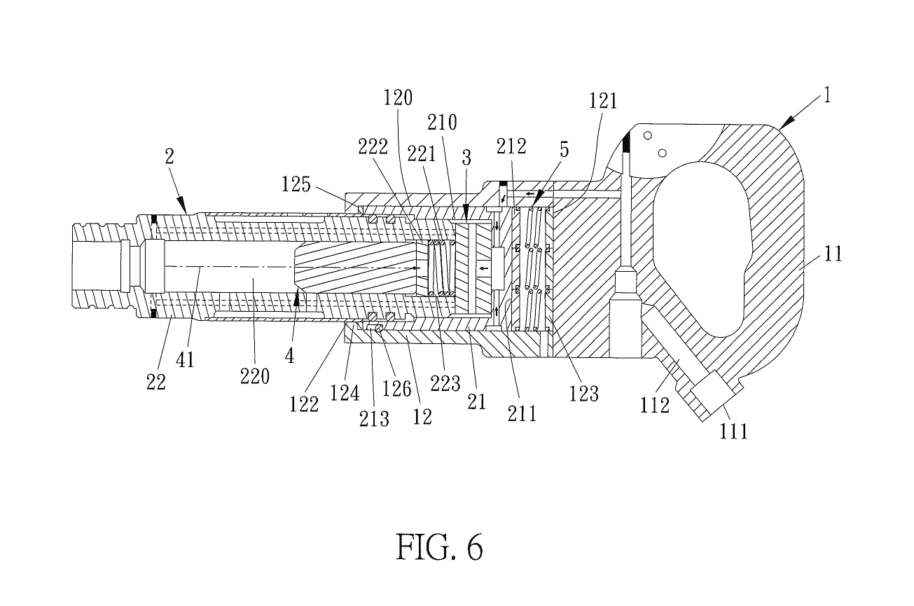

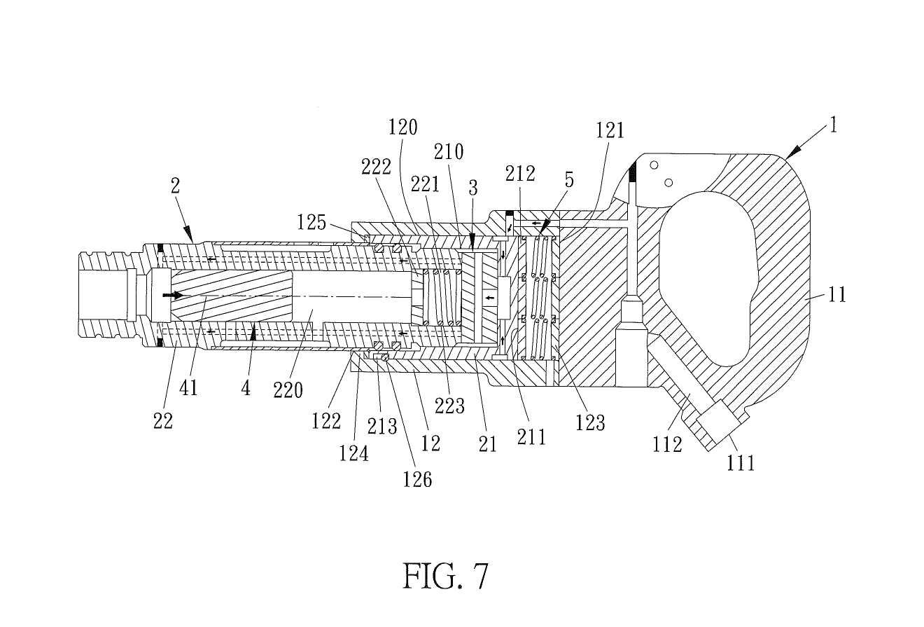

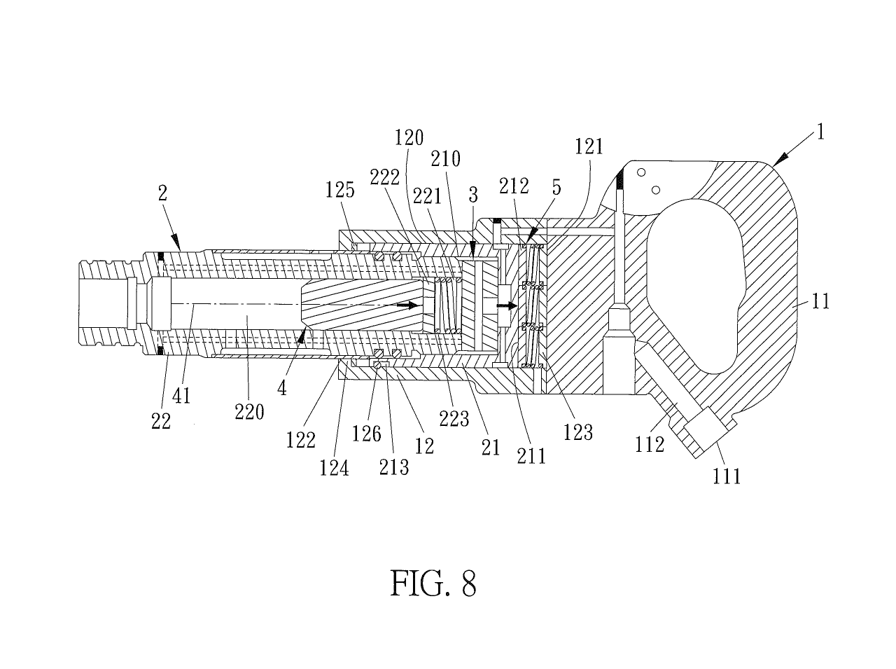

After the control switch on the grip 11, as shown in FIG. 6, is turned on, the high pressure air flows into the valve unit 3 through the air passage 112 of the grip 11, and then the high pressure air flows into the room 220 of the base 22 from the valve unit 3 to push the piston member 4 to slide toward a front end of the room 220, such that a tool head (not shown) is hit by the piston member 4, and the piston member 4 is stopped by the tool head, as shown in FIGS. 7 and 8, thereafter the high pressure air flows into the room 220 of the cylinder 22 through the valve unit 3 to push the piston member 4 to move toward a rear end of the room 220, and then the piston member 4 hits the valve unit 3 so that the cylinder 2 is driven to move backward, and the plural buffer springs 5 are biased against the close face 121 of the chamber 120 of the fitting sleeve 12 and the abutting portion 211 of the sliding sleeve 21 of the cylinder 2 to disperse and to buffer a reaction force, thus absorbing shock and reducing the reaction force to push the piston member 4 forward and backward.

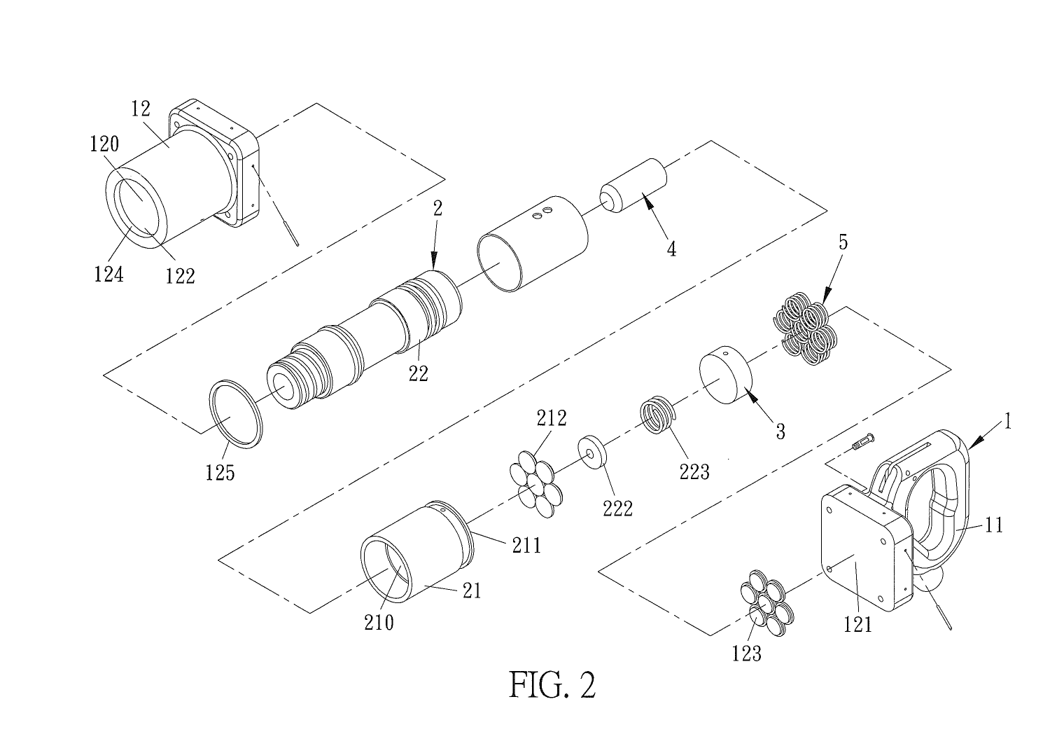

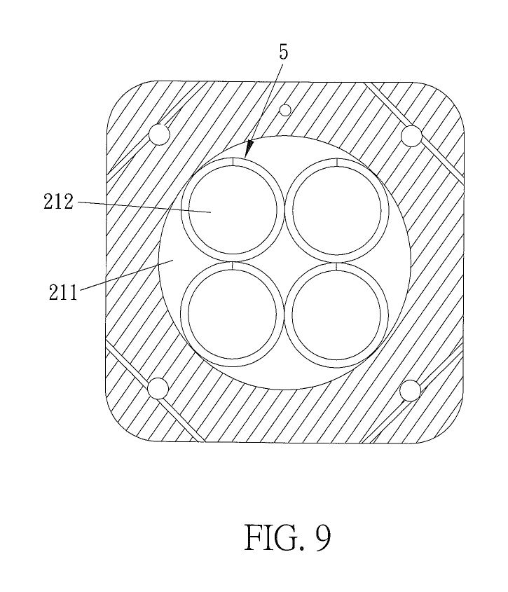

As shown in FIG. 2, the plural buffer springs 5 are arranged in a circle array. As illustrated in FIG. 9, the plural buffer springs 5 are arranged in a rectangle array, and the plurality of first fixing portions 123 of the close face 121 and the plurality of second fixing portions 212 of the abutting portion 211 are arranged in a rectangle array, such that two ends of each buffer spring 5 are fitted with each first fixing portion 123 of the close face 121 and each second fixing portion 212 of the abutting portion 211, hence the plural buffer springs 5 positioned separately.

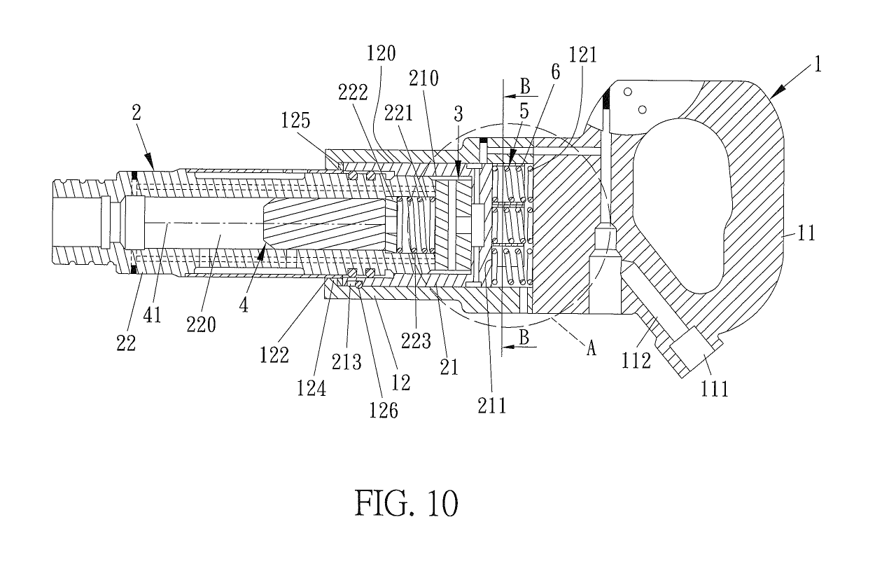

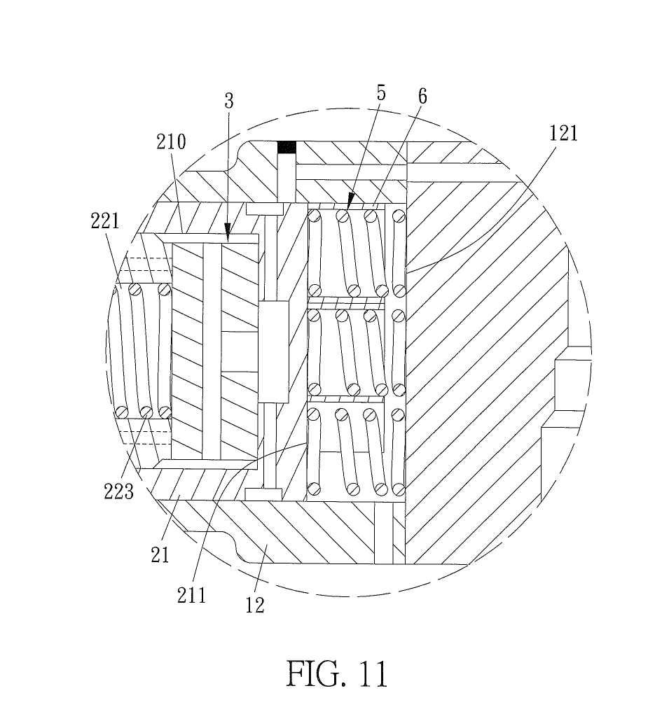

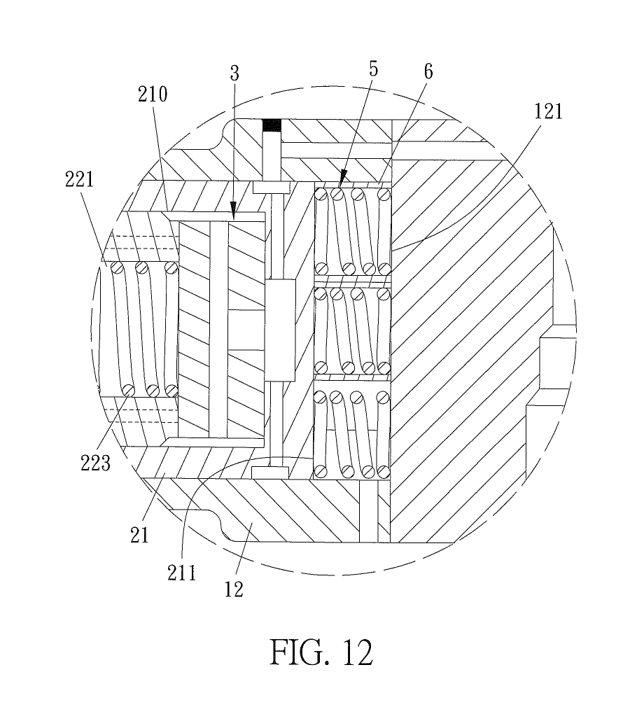

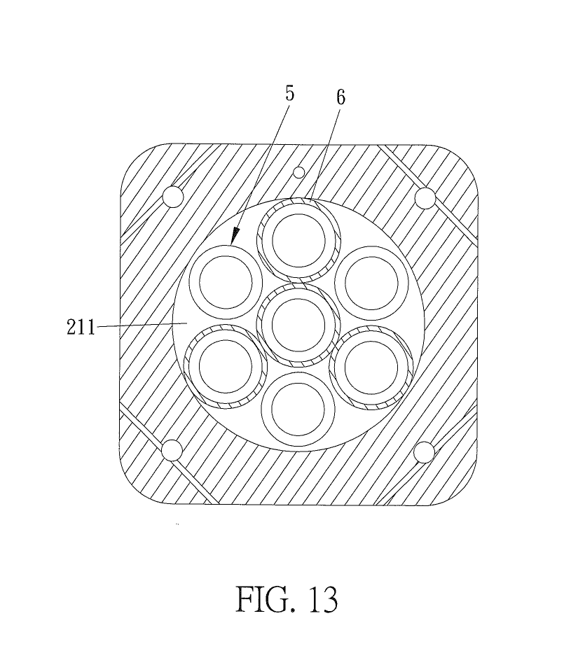

With reference to FIGS. 10 to 13, between the close face 121 of the chamber 120 of the fitting sleeve 12 and the abutting portion 211 of the sliding sleeve 21 of the cylinder 2 are defined a plurality of affix sheathes 6, such that the plurality of affix sheathes 6 fix and separate the plural buffer springs 5, thus limiting maximum compressing capacity of the plural buffer springs 5 and prolonging using lifespan of the plural buffer springs 5.

Accordingly, the shock absorption device of the present invention contains the plural buffer springs 5 which are mounted in the chamber 120 of the fitting sleeve 12 and abut against the close face 121 of the chamber 120 of the fitting sleeve 12 and the abutting portion 211 of the sliding sleeve 21 of the cylinder 2, such that the plural elastic supporting points form between the close face 121 and the abutting portion 211, and when the piston member 4 moves backward to impact the valve unit 3, the plural buffer springs 5 buffer the reaction force, such that the shock is absorbed and the reaction force which passes to user's hand is reduced, thus operating the pneumatic tool easily and protecting the user's wrist.

While various embodiments in accordance with the present invention have been shown and described, it is clear to those skilled in the art that further embodiments may be made without departing from the scope of the present invention.

What is claimed is:

1. A shock absorption device for a pneumatic tool, wherein a pneumatic tool comprises:
a body including a grip and a fitting sleeve fitted with the grip, the fitting sleeve having a chamber defined therein, a close face formed on a first end thereof, and an opening formed on a second end thereof;
a cylinder slidably fixed in the chamber of the fitting sleeve and a part thereof extending out of the opening of the fitting sleeve, the cylinder including a room defined therein and an abutting portion adjacent to the close face of the chamber of the fitting sleeve;
a valve unit fixed between the room and the abutting portion of the cylinder;
a piston member accommodated in the room of the body and sliding forward and backward along a movement axis; plural buffer springs mounted in the chamber of the fitting sleeve and abutting against the close face of the chamber of the fitting sleeve and the abutting portion of the cylinder, wherein a pressing direction of each buffer spring is parallel to the movement axis of the piston member, and plural elastic supporting points form between the close face and the abutting portion.

2. The shock absorption device for the pneumatic tool as claimed in claim 1, wherein the close face of the fitting sleeve has a plurality of first fixing portions arranged thereon, and a plurality of second fixing portions are arranged on one surface of the abutting portion opposite to the close face of the chamber of the fitting sleeve, wherein two ends of each buffer spring are fitted with each first fixing portion of the close face and each second fixing portion of the abutting portion.

3. The shock absorption device for the pneumatic tool as claimed in claim 2, wherein the plurality of first fixing portions are circularly arranged on the close face of the fitting sleeve, and the plurality of second fixing portions are circularly arranged on the one surface of the abutting portion, the plural buffer springs are circularly mounted in the chamber of the fitting sleeve and abut against the close face of the chamber of the fitting sleeve and the abutting portion of the cylinder.

4. The shock absorption device for the pneumatic tool as claimed in claim 2, wherein the plurality of first fixing portions of the close face and the plurality of second fixing portions of the abutting portion are arranged in a rectangle array, the plural buffer springs are arranged in a rectangle array, such that the plural buffer spring abut against the close face of the chamber of the fitting sleeve and the abutting portion of the cylinder.

5. The shock absorption device for the pneumatic tool as claimed in claim 1, wherein a stop rib extends inwardly from a peripheral side of the opening, and the cylinder is stopped by the stop rib of the fitting sleeve for matching with a washer.

6. The shock absorption device for the pneumatic tool as claimed in claim 1, wherein the cylinder includes a sliding sleeve and a base, wherein the sliding sleeve is slidably fitted in the chamber of the fitting sleeve, and the sliding sleeve has a hollow portion formed therein, wherein the abutting portion of the cylinder is fixed on one end of the hollow portion adjacent to the close face of the chamber of the fitting sleeve, and one end of the base is inserted into the hollow portion of the sliding sleeve and is connected with the sliding sleeve in a screwing manner.

7. The shock absorption device for the pneumatic tool as claimed in claim 6, wherein the sliding sleeve has a limiting slot defined on an outer side thereof to insert a defining element of the fitting sleeve.

8. The shock absorption device for the pneumatic tool as claimed in claim 1, wherein between the close face of the chamber of the fitting sleeve and the abutting portion of the cylinder are defined a plurality of affix sheathes, such that the plurality of affix sheathes fix and separate the plural buffer springs.
